(19) United States
(12) Patent Application Publication
(10) Pub. No.: US 2026/0148710 A1
(43) Pub. Date: May 28, 2026

(54) DISPLAY DEVICE AND DRIVING METHOD THEREOF

(71) Applicant: Japan Display Inc., Tokyo (JP)

(72) Inventor: Masataka IKEDA, Tokyo (JP)

(73) Assignee: Japan Display Inc., Tokyo (JP)

(21) Appl. No.: 19/387,680

(22) Filed: Nov. 13, 2025

(30) Foreign Application Priority Data
Nov. 27, 2024 (JP) 2024-206001
Sep. 2, 2025 (JP) 2025-145294

(51) Int. Cl. G09G 3/34

(52) U.S. Cl. CPC G09G 3/3426; G09G 2310/08; G09G 2320/0233; G09G 2330/021

(57) ABSTRACT

A display device includes a plurality of pixels arranged in a matrix form with a plurality of rows and a plurality of columns each including a transistor and a liquid crystal element electrically connected to the transistor, as well as a red-emissive light-emitting element, a green-emissive light-emitting element, and a blue-emissive light-emitting element configured to apply light to the plurality of pixels. The driving method includes, in a first frame period; inputting image signals to the plurality of pixels in a row order; and turning on one of the red-emissive light-emitting element, the green-emissive light-emitting element, and the blue-emissive light-emitting element after inputting the image signals to the plurality of pixels. In the first frame period, the transistors are each maintained in an off state after inputting the image signals into the plurality of pixels.

### CROSS-REFERENCE TO RELATED APPLICATIONS

This application claims the benefit of priority to Japanese Patent Application No. 2024-206001, filed on Nov. 27, 2024, and Japanese Patent Application No. 2025-145294, filed on Sep. 2, 2025, the entire contents of each are incorporated herein by reference.

### FIELD

An embodiment of the present invention relates to a display device and a driving method thereof.

### BACKGROUND

Liquid crystal displays are used in a variety of electronic devices such as smartphones, cellular phones, tablets, televisions, computers, signage, head-mounted displays, and portable gaming devices. Therefore, a variety of methods have been proposed to drive liquid crystal displays depending on their size and applications. For example, Japanese Laid-Open Patent Publication No. 2019-78979 discloses a method of driving liquid crystal displays using the common-inversion method. In this method, a constant potential is applied to all of the pixels before reversing the polarity of a potential of a common electrode, thereby reducing the operating voltage.

### SUMMARY

An embodiment of the present invention is a driving method of a display device. The display device has a plurality of pixels in addition to a red-emissive light-emitting element, a green-emissive light-emitting element, and a blue-emissive light-emitting element. The plurality of pixels each has a transistor and a liquid crystal element electrically connected to the transistor. The red-emissive light-emitting element, the green-emissive light-emitting element, and the blue-emissive light-emitting element are configured to apply light to the plurality of pixels. The driving method includes, in a first frame period: inputting image signals to the plurality of pixels: turning on one of the red-emissive light-emitting element, the green-emissive light-emitting element, and the blue-emissive light-emitting element after inputting the image signals to the plurality of pixels; and maintaining the transistors of the plurality of pixels in an off state after inputting the image signals to the plurality of pixels until a start of a second frame period subsequent to the first frame period.

An embodiment of the present invention is a display device. The display device has a plurality of pixels, a driver circuit for controlling the plurality of pixels, a red-emissive light-emitting element, a green-emissive light-emitting element, a blue-emissive light-emitting element, and a light-source driver circuit. The plurality of pixels each has a transistor and a liquid crystal element electrically connected to the transistor. The red-emissive light-emitting element, the green-emissive light-emitting element, and the blue-emissive light-emitting element are configured to apply light to the plurality of pixels. The light-source driver circuit is configured to control the red-emissive light-emitting element, the green-emissive light-emitting element, and the blue-emissive light-emitting element. The driver circuit is configured to input image signals to the plurality of pixels in a first frame period. The light-source driver circuit is configured to turn on one of the red-emissive light-emitting element, the green-emissive light-emitting element, and the blue-emissive light-emitting element after inputting the image signals to the plurality of pixels in the first frame period. The driver circuit is further configured to maintain the transistors of the plurality of pixels in an off state in the first frame period until a start of a second frame period subsequent to the first frame period.

### BRIEF DESCRIPTION OF DRAWINGS

FIG. 1 is a schematic developed view of a display device according to an embodiment of the present invention.

FIG. 2 is a schematic perspective view of a display device according to an embodiment of the present invention.

FIG. 3 is a schematic cross-sectional view of a display device according to an embodiment of the present invention.

FIG. 4 is an equivalent circuit diagram of a pixel of a display device according to an embodiment of the present invention.

FIG. 5 is a schematic cross-sectional view of a display device according to an embodiment of the present invention.

FIG. 6 is a schematic cross-sectional view of a display device according to an embodiment of the present invention.

FIG. 7 is a schematic cross-sectional view of a display device according to an embodiment of the present invention.

FIG. 8 is a schematic top view of a transistor included in a pixel of a display device according to an embodiment of the present invention.

FIG. 9 is a schematic top view of a transistor included in a pixel of a display device according to an embodiment of the present invention.

FIG. 10 is a timing chart showing a driving method according to an embodiment of the present invention.

FIG. 11 is a timing chart showing a driving method according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate. When a plurality of structures the same as or similar to each other is collectively represented, this reference number is used, while a hyphen and a natural number are added after the reference number when these structures are independently represented.

In the present application, when a plurality of films is formed by processing one film, the plurality of films may have difference functions and roles. However, since the plurality of films results from a film formed as the same layer in the same process, they have substantially the same layer structure, the same material, and the same morphology. Hence, the plurality of films is defined as existing in the same layer.

In the specification and the claims, unless specifically stated, when a state is expressed where a structure is arranged “over” another structure, such an expression includes both a case where the structure is arranged immediately above the “other structure” so as to be in contact with the “other structure” and a case where the structure is arranged over the “other structure” with an additional structure therebetween.

In the specification and the claims, an expression “a structure is exposed from another structure” means a mode in which a part of the structure is not covered by the other structure and includes a mode where the part uncovered by the other structure is further covered by another structure. In addition, a mode expressed by this expression includes a mode where a structure is not in contact with other structures.

### 1. Overall Structure of Display Device

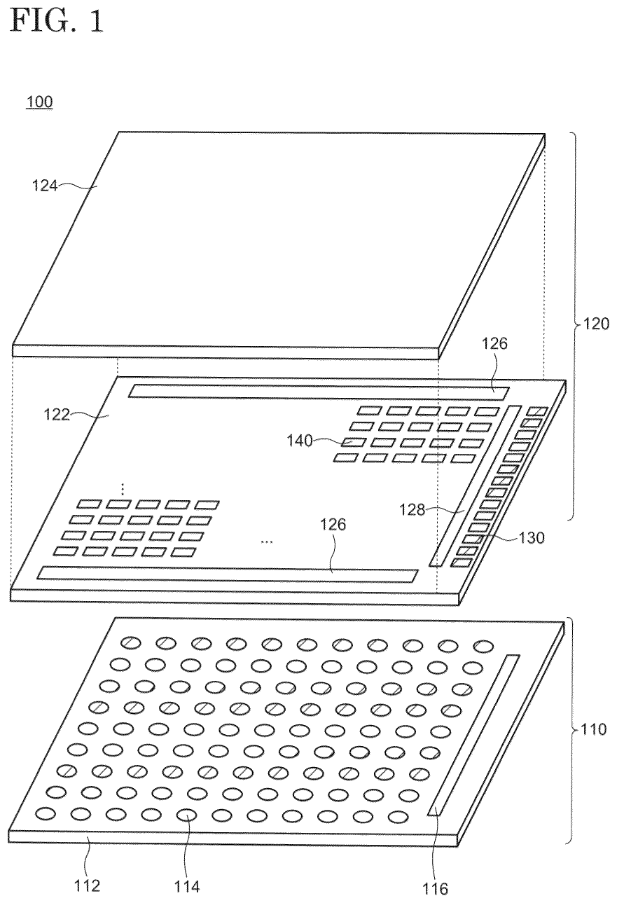

FIG. 1 shows a schematic developed view of a display device 100 according to an embodiment of the present invention. The display device 100 is a liquid crystal display device and has a light-source unit 110 and a display unit 120. Hereinafter, the light-source unit 110 and the display unit 120 are explained.

### (1) Light-Source Unit

In the example shown in FIG. 1, the light-source unit 110 has a light-source substrate 112 as well as a plurality of light-emitting elements 114 and a light-source driver circuit 116 disposed over the light-source substrate 112. The light-source substrate 112 is arranged within a housing which is not illustrated. The plurality of light-emitting elements 114 is each composed of an inorganic light-emitting diode (LED) and is arranged to apply light in three primary colors to the display unit 120. More specifically, a plurality of red-emissive light-emitting elements 114, a plurality of green-emissive light-emitting elements 114, and a plurality of blue-emissive light-emitting elements 114 each including an LED are arranged over the light-source substrate 112. The light-source driver circuit 116 is supplied with power and control signals from an external circuit, which is not illustrated, via a connector such as a flexible printed circuit (FPC) board (not illustrated). The light-source driver circuit 116 is configured to be able to perform the driving method described below, generates signals for controlling the plurality of light-emitting elements 114 on the basis of the input control signals, and supplies them to the plurality of light-emitting elements 114. As a result, light from the light-emitting elements 114 is applied to the pixels of the display unit 120 described below. As described below, the so-called field-sequential driving method is employed in the display unit 100. Accordingly, the light-source driver circuit 116 is configured to cause the plurality of red-emissive light-emitting elements 114, the plurality of green-emissive light-emitting elements 114, and the plurality of blue-emissive light-emitting elements 114 to sequentially emit light in each frame period. Although not illustrated, a light-diffusion plate, a prism sheet, and the like are provided between the light-source unit 110 and the display unit 120. This configuration allows the light from the light-source unit 110 to be uniformly applied to the display unit 120.

### (2) Display Unit

The display unit 120 has an array substrate 122 and a counter substrate 124 facing the array substrate 122. The array substrate 122 and the counter substrate 124 are secured to each other by a sealing material which is not illustrated. A variety of patterned conductive films, semiconductor films, insulating films, and the like formed using photolithography processes is arranged over the array substrate 122. Appropriate combination of these conductive films, semiconductor films, insulating films, and the like results in the formation of a plurality of pixels 140 as well as driver circuits for driving the pixels 140 (a gate-line driver circuit 126 and a signal-line driver circuit 128), a plurality of terminals 130 electrically connected to the driver circuits, and the like. Note that a part of the driver circuits (e.g., all or part of the signal-line driver circuit 128) may be formed using an integrated circuit formed over a semiconductor substrate.

As shown in FIG. 1, the plurality of pixels 140 is arranged in a matrix form having a plurality of rows and a plurality of columns. As described below, each pixel 140 is provided with a liquid crystal element as a display element and functions as the smallest unit providing color information. The smallest region including the plurality of pixels 140 and a region between adjacent pixels 140 is a display region, while the region surrounding the display region and provided with the driver circuits, the terminals 130, and the like is a frame region. Although not depicted in FIG. 1, a plurality of gate lines, a plurality of image-signal lines, and the like are formed over the array substrate 122 with patterned conductive films. The plurality of gate lines extends in a row direction from the gate-line driver circuit 126 to reach the display region, while the plurality of image-signal lines extends in a column direction from the signal-line driver circuit 128 to reach the display region.

The plurality of terminals 130 is arranged in parallel to the row direction or the column direction. Although not illustrated, the plurality of terminals 130 is connected to an external circuit, which is not illustrated, via a connector such as an FPC, and a variety of control signals and power for driving the pixels 140 are supplied from the external circuit to the driver circuits via the connector and the terminals 130. The gate-line driver circuit 126 generates gate signals on the basis of the control signals supplied from the external circuit and supplies them to the pixels 140 via the plurality of gate lines so that the driving method described below can be executed. Meanwhile, the signal-line driver circuit 128 generates a variety of signals including image signals on the basis of the control signals supplied from the external circuit and supplies them to the pixels 140 via the plurality of image-signal lines so that the driving method described below can be executed. The plurality of pixels 140 are controlled by these signals, by which images are reproduced in the display region.

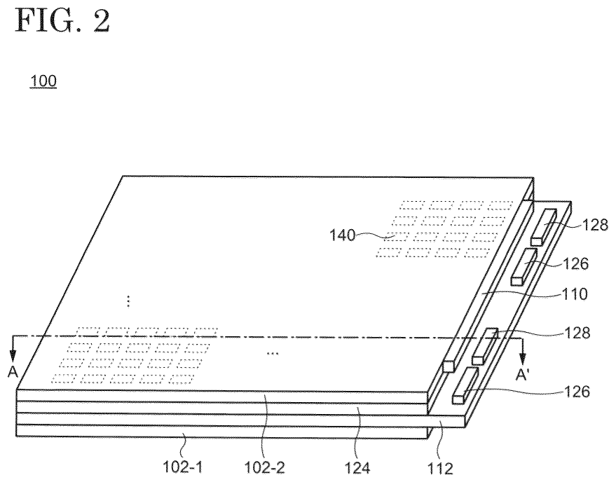

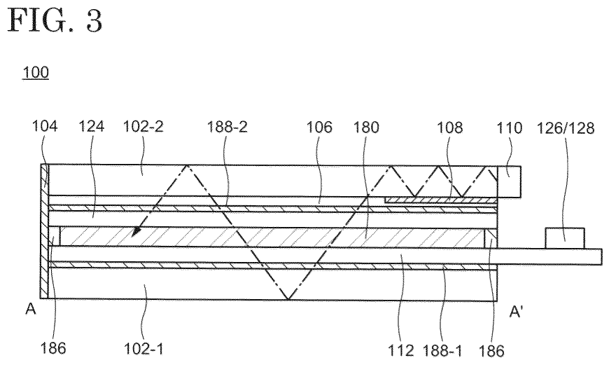

In the example shown in FIG. 1, the light-source unit 110 is arranged to overlap the plurality of pixels 140 in the normal direction of the main surface of the array substrate 122 or the counter substrate 124, and the light from the light-emitting elements 114 is applied onto the pixels 140. However, the arrangement of the light-source unit 110 and the display unit 120 is not limited thereto. For example, the light-source unit 110 may be arranged over the array substrate 122 so as not to overlap the display region, and a pair of light-guide plates 102-1 and 102-2 may be provided to sandwich the array substrate 122 and the counter substrate 124 as shown in FIG. 2. As demonstrated in the schematic view of the cross section along the chain line A-A′ in FIG. 2 (FIG. 3), the pair of light-guide plates 102-1 and 102-2 are fixed to the array substrate 122 and the counter substrate 124 with adhesive layers 188-1 and 188-2 transmitting visible light, respectively. The array substrate 122 and the counter substrate 124 are secured to each other with the sealing material 186 arranged to surround the display region, and a liquid crystal layer 180 is sealed within the space formed by the array substrate 122, the counter substrate 124, and the sealing material 186. In the light-source unit 110, the plurality of light-emitting elements 114 is arranged in the row direction or the column direction, and the light-source unit 110 is arranged to apply the light onto the side surface of the light-guide plate 102-2.

Furthermore, a low-refractive index layer 108 is provided on the surface of the light-guide plate 102-2 on the liquid crystal layer 180 side. The low-refractive index layer 108 is configured to have a refractive index lower than the refractive indices of the array substrate 122, the counter substrate 124, and the light-guide plate 102. The low-refractive index layer 108 is provided on the light-source unit 110 side of the light-guide plate 102-1 and overlaps a part of the display region. In other words, a portion of the display region on the side of the light-source unit 110 is covered by the low-refractive index layer 108, while the other portion is exposed from the low-refractive index layer 108. Furthermore, a protective film 106 having a transmitting property with respect to visible light is formed to the light-guide plate 102-2 so as to cover the low-refractive index layer 108. On the other hand, a mirror 104 for reflecting the light emitted from the light-source unit 110 is arranged on the opposite side of the light-guide plate 102, the array substrate 122, and the counter substrate 124 with respect to the light-source unit 110 to cover the side surfaces thereof.

This configuration allows the light, which is incident on the light-guide plate 102-1 from the light-emitting elements 114 through the side surface of the light-guide plate 102-1 on the light-source unit 110 side, to be repeatedly reflected between the main surfaces of the light-guide plates 102-1 and 102-2 due to the difference in refractive index between the light-guide plates 102 and air and to be applied to the pixels 140 (see the chain lines in FIG. 3). In this configuration, the pixels 140 included in the display unit 120 and the light-source unit 110 do not overlap in the normal direction of the main surface of the array substrate 122 or the counter substrate 124. Therefore, the display unit 100 is able to function as a display device transmitting visible light, i.e., a transparent display, when each pixel 140 is configured to transmit at least a part of visible light. In addition, the critical angle of the light incident on the low-refractive index layer 108 can be smaller than the critical angle of the light incident on the adhesive layer 188 by providing the low-refractive index layer 108. Therefore, the amount of light totally reflected in the region where the low-refractive index layer 108 is provided, i.e., on the side of the display region where the light-source unit 110 is provided, can be increased. As a result, a sufficient amount of light can be supplied to the display region on the opposite side with respect to the light-source unit 110. This mechanism can suppress the occurrence of uneven luminance in the display region and ensure uniform luminance over the entire display region.

### 2. Structure of Pixel

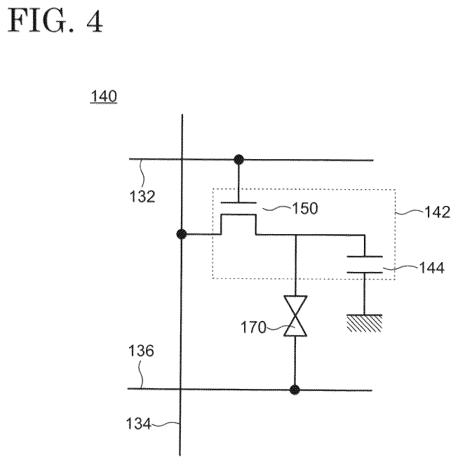

FIG. 4 shows an equivalent circuit diagram of one pixel 140. A pixel circuit 142 and a liquid crystal element 170 functioning as a display element are formed in each pixel 140. The pixel circuit 142 is electrically connected to one respective gate line 132 and one image-signal line 134, and the liquid crystal element 170 is electrically connected to the pixel circuit 142 as well as a common line 136. Thus, one gate line 132 is electrically connected to a plurality of pixel circuits 142 arranged in the row direction, while one image-signal line 134 is electrically connected to a plurality of pixel circuits 142 arranged in the column direction. The common line 136 is electrically connected to the liquid crystal elements 170 of all of the pixels 140. There is no restriction on the configuration of the pixel circuit 142, and each pixel circuit 142 may be composed of at least one transistor 150 and one storage capacitor element 144 as shown in FIG. 4. In this case, a gate of the transistor 150 is electrically connected to the gate line 132, one terminal is electrically connected to the image-signal line 134, and the other terminal is electrically connected to one electrode of the storage capacitor element 144 and the liquid crystal element 170. The other electrode of the storage capacitor element 144 is electrically connected to a capacitor line (not illustrated) to which a constant potential is supplied. The other electrode of the storage capacitor element 144 may be connected to the common line 136. The configuration of the pixel circuit 142 is also not limited to the configuration shown in FIG. 4, and each pixel circuit 142 may further have one or a plurality of transistors and one or a plurality of storage capacitor elements.

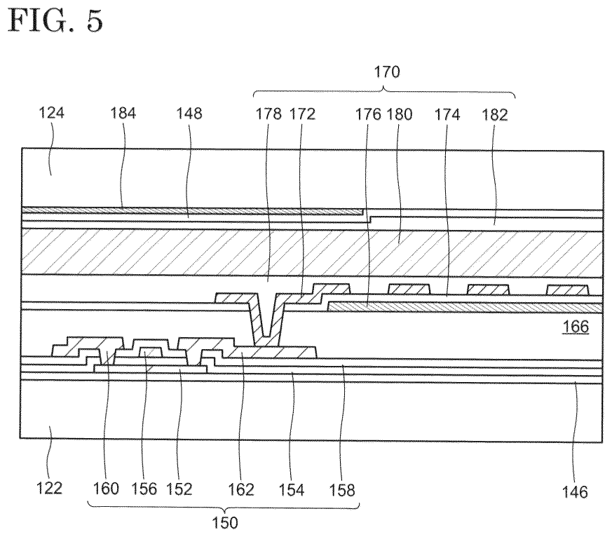

The structure of the liquid crystal element 170 is also not limited. For example, the liquid crystal element 170 may be the so-called TN (Twist Nematic) liquid crystal element or the VA (Vertical Alignment) liquid crystal element. Alternatively, the liquid crystal element 170 may be the IPS (In-Plane Switching) liquid crystal element. As an example, a schematic cross-sectional view of the display unit 120 including one pixel 140 having an IPS liquid crystal element as the liquid crystal element 170 is shown in FIG. 5. The elements structuring the pixel circuit 142 (e.g., transistors 150) are provided over the array substrate 122 either directly or through an undercoat 146 which is an optional component. In the example shown in FIG. 5, the transistor 150 is a top-gate type transistor and includes a semiconductor film 152, a gate insulating film 154 covering the semiconductor film 152, a gate electrode 156 overlapping the semiconductor film 152 through the gate insulating film 154, one or a plurality of interlayer insulating films 158 covering the gate electrode 156, and a pair of terminals 160 and 162 electrically connected to the semiconductor film 152 through openings formed in the interlayer insulating film 158 and the gate insulating film 154.

A leveling film 166 is provided over the pixel circuits to absorb unevenness caused by the transistor 150 and the like and provide a flat surface, and the liquid crystal element 170 is arranged over the leveling film 166. The liquid crystal element 170 has a common electrode 176 arranged over the leveling film 166, a pixel electrode 172 electrically connected to the terminal 162 and having a comb-like top-surface shape, an interelectrode insulating film 174 electrically insulating the pixel electrode 172 and the common electrode 176, a first orientation film 178 over the pixel electrode 172 and the common electrode 176, a liquid crystal layer 180 over the first orientation film 178, and a second orientation film 182 over the liquid crystal layer 180. A light-shielding film 184 overlapping the pixel circuit 142, an overcoat 148 covering the light-shielding film 184, and the like may be provided over the counter substrate 124 (under the counter substrate 124 in FIG. 5). As described above, since the display device 100 is driven by the field-sequential method, light of different colors is not simultaneously emitted from the light-source unit 110. Therefore, there is no need to provide a color filter.

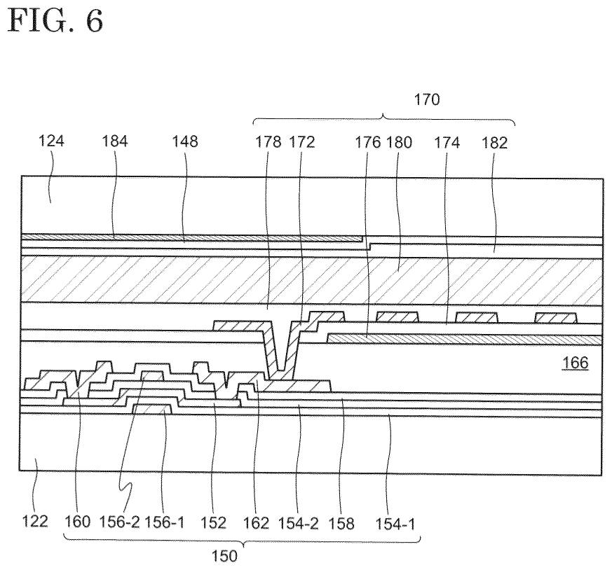

The structure of the transistor 150 is not limited to the structure described above, and a bottom-gate type transistor may be employed as the transistor 150. Alternatively, the transistor 150 may be a transistor having a pair of gate electrodes 156-1 and 156-2 vertically sandwiching the channel formed in the semiconductor film 152 as shown in FIG. 6. In this case, a first gate insulating film 154-1 is provided between one gate electrode 156-1 and the semiconductor film 152, while a second gate insulating film 154-2 is provided between the semiconductor film 152 and the other gate electrode 156-2. The pair of gate electrodes 156-1 and 156-2 are electrically connected to each other and may be equipotential.

The undercoat 146, the gate insulating film 154, the interlayer insulating film 158, the interelectrode insulating film 174, the undercoat 146, and the like described above may be composed of one or a plurality of films containing a silicon-containing inorganic compound such as silicon oxide and silicon nitride. These films are formed using a sputtering method, a chemical vapor deposition (CVD) method, or the like. The gate electrode 156 and the terminals 160 and 162 may be configured to include a metal such as molybdenum, tantalum, titanium, tungsten, aluminum, and copper or an alloy containing a metal selected from these metals. The gate electrode 156 and the terminals 160 and 162 may have a single-layer structure or a stacked-layer structure. The gate electrode 156 and the terminals 160 and 162 may also be formed using a sputtering method or a CVD method. The pixel electrode 172 and the common electrode 176 are composed of a conductive oxide such as indium-tin oxide and indium-zinc oxide to transmit visible light, thereby providing the liquid crystal element 170 with a light-transmitting property. The pixel electrode 172 and the common electrode 176 may be formed using a sputtering method. The first orientation film 178 and the second orientation film 182 include a polymer such as a polyimide and a polyamide, and their surfaces are subjected to a rubbing treatment. Alternatively, the first orientation film 178 and the second orientation film 182 may be formed using photoalignment. In this case, the rubbing treatment may not be required. Accordingly, the orientation of the liquid crystal molecules in the liquid crystal layer 180 can be controlled. The light-shielding film 184 may be formed with a metal with low reflectance to visible light, such as chrome, or with a resin containing black or similarly colored pigment.

There are also no restrictions on the structure of the liquid crystal layer 180, and the liquid crystal molecules included in the liquid crystal layer 180 may be a nematic liquid crystal, a smectic liquid crystal, a cholesteric liquid crystal, or a chiral smectic liquid crystal. Alternatively, the liquid crystal layer 180 may be a polymer-dispersed liquid crystal. Since a polymer-dispersed liquid crystal is able to take a non-scattering state and a scattering state depending on the voltage applied thereto, it is possible to provide a light-transmitting property to the display device 100 when applying a polymer-dispersed liquid crystal to the display device 100 shown in FIG. 2 and FIG. 3 and allowing the liquid crystal layer 180 to take the non-scattering state. On the other hand, since light can be scattered in the scattering state, the light propagated by the light-guide plates 102-1 and 102 can be scattered and used for display. Accordingly, a transparent display can be structured.

The semiconductor film 152 may be composed of a Group 14 element exemplified by silicon or an oxide semiconductor containing indium. There is no restriction on the crystallinity of the semiconductor film 152, and the semiconductor film 152 may be amorphous or polycrystalline. For example, when the semiconductor film 152 contains or consists of an oxide semiconductor, the semiconductor film 152 is preferred to include indium and a metal element other than indium. The semiconductor film 152 containing or consisting of an oxide semiconductor may be formed by a sputtering method or an atomic-layer deposition (ALD) method. For example, an amorphous oxide semiconductor film is formed using a sputtering method, and an etching process is performed thereon to form the semiconductor film 152. The semiconductor film 152 is then annealed at a high temperature (e.g., equal to or higher than 300° C. and equal to or lower than 500° C. or equal to or higher than 350° C. and equal to or lower than 450° C.).

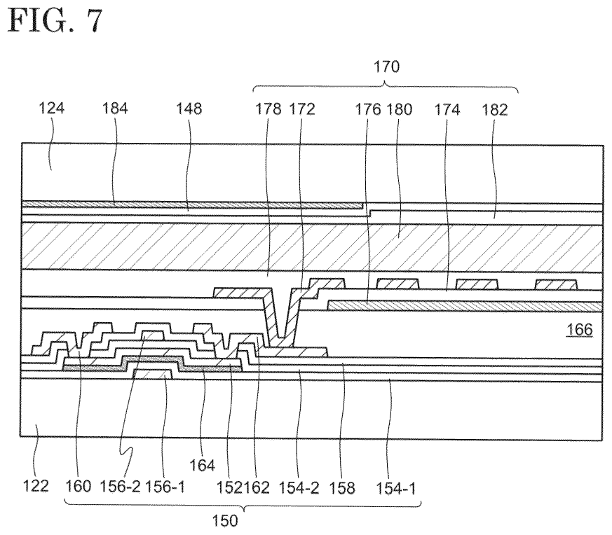

Further, the transistor 150 may have a metal-oxide film 164 under and in contact with the semiconductor film 152 as shown in FIG. 7. The metal-oxide film 164 is a film containing aluminum oxide as a main component and may consist of aluminum oxide. The metal-oxide film 164 blocks hydrogen and oxygen eliminated from the first gate insulating film 154-1 (undercoat 146 when a top-gate type transistor is employed) located under the metal-oxide film 164 and prevents hydrogen and oxygen from entering the semiconductor film 152 containing an oxide semiconductor. Accordingly, characteristic deterioration of the transistor 150 caused by trapping of hydrogen in oxygen defects in the semiconductor film 152 can be prevented. In addition, the formation of defect levels generated by an excessive supply of oxygen to the semiconductor film 152 can also be prevented. Due to these effects, the formation of the metal-oxide film 164 enables the formation of the semiconductor film 152 with fewer oxygen defects, and thus the transistor 150 with even higher mobility can be fabricated.

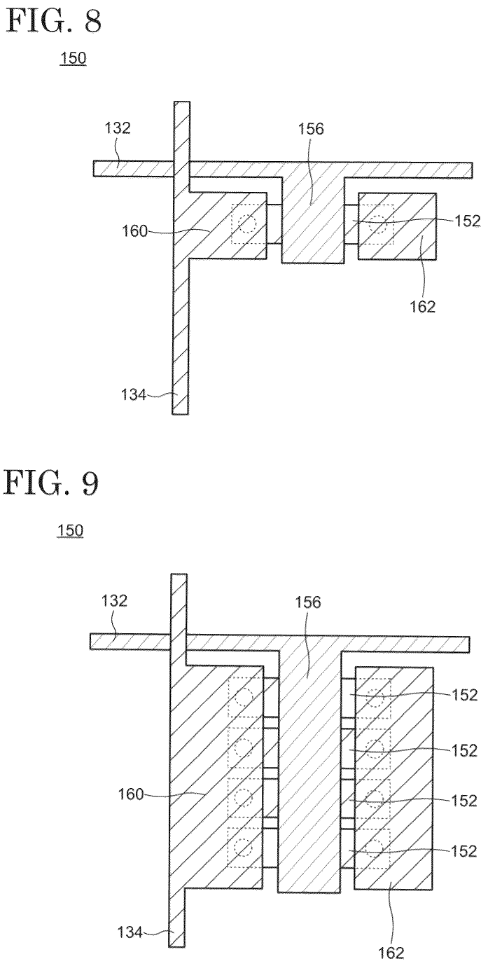

FIG. 8 shows a schematic top view of the transistor 150. As shown in FIG. 8, a portion of the gate line 132 extending from the gate-line driver circuit 126 functions as the gate electrode 156 and overlaps the semiconductor film 152. A portion of the image-signal line 134 extending from the signal-line driver circuit 128 functions as the terminal 160 and is electrically connected to the semiconductor film 152 through a contact hole indicated by the dotted circle. Similar to the terminal 160, the terminal 162 existing in the same layer as the terminal 160 is electrically connected to the semiconductor film 152. When a potential higher than the threshold value is supplied to the gate electrode 156, the transistor 150 is turned on, and the signals such as image signals supplied to the image-signal line 134 are supplied from the terminal 160 to the terminal 162 through the semiconductor film 152. As a result, a potential corresponding to the image signal is input to the pixel 140.

Although the transistor 150 shown in FIG. 8 has a single channel formed by one semiconductor film 152, the transistor 150 may have a plurality of channels (multi-channel) arranged parallel to one another. Specifically, the transistor 150 may have a plurality of semiconductor films 152 arranged parallel to one another, each overlapping the gate electrode 156, and electrically connected to the terminals 160 and 162 as shown in FIG. 9. There is no restriction on the number of semiconductor films 152, and the number of semiconductor films 152 may be selected from a range equal to or greater than 2 and equal to or less than 6, for example. The formation of a plurality of channels with a plurality of semiconductor films 152 decreases the amount of heat generated when the transistor 150 is driven compared with the case where one semiconductor film 152 having the same width as the total width of the channels is provided, and as a result, the ON resistance of the transistor 150 can be reduced.

### 3. Driving Method of Display Device

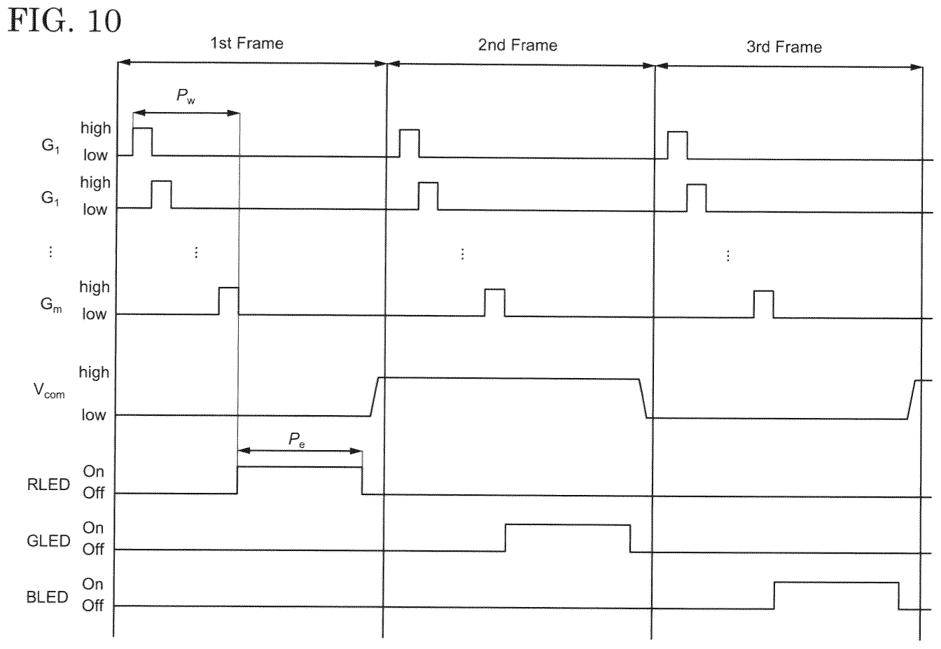

FIG. 10 shows a timing chart illustrating the driving method of the display device 100. This drawing shows the potential change of all of the gate lines 132, the potential change of the common electrode 176, and the states of the red-, green-, and blue-emissive light-emitting elements 114 over three consecutive frame periods (first frame period, second frame period, and third frame period). The total number of gate lines 132 is m (m is selected from an integer equal to or greater than 2 and is 480, for example), and the potentials of the gate lines 132 are shown as G₁ to Gₘ in FIG. 10. Moreover, the potential of the common electrode 176 is shown as V_{com}, and the states of the red-, green-, and blue-emissive light-emitting elements 114 are respectively shown as RLED, GLED, and BLED in FIG. 10. The light-emitting elements 114 emit light in the on state and do not emit light in the off state. Although the polarity of the gate potential required to turn on and off the transistors depends on the polarity of the transistors, the following description is provided on an assumption that when a high potential (high) is input to gate line 132, the transistor 150 in the pixel circuit 142 connected thereto shifts to the on state.

The length of one frame period may be arbitrarily set according to the refresh rate. For example, the length of one frame period may be arbitrarily set between 1/180 second and 1/360 second. Alternatively, the length of one frame period may be equal to or less than 1/360 second.

### (1) Writing Period

When one frame period starts, the image signals are first written (input) to all of the pixels 140. Specifically, the potentials of the gate lines 132 of the first row to the mth row are changed from a low potential to a high potential in order from the first row as shown in FIG. 10, by which the transistors 150 of the pixel circuits 142 connected to the gate lines 132 are turned on in order from the first row. At the same time, the image signals corresponding to the image are supplied to the image-signal lines 134 for each row. As a result, the image signal is input to each pixel 140. The period during which the image signals are input to all of the pixels 140 is a writing period P_{w}, and the ratio of the writing period P_{w} to one frame period is set to be equal to or greater than 0.14 and equal to or less than 0.71.

When the input of the image signals is completed in each row, the potentials of the gate lines 132 become low, the transistors 150 shift to the off state, and the off state is then maintained until the next frame period.

### (2) Emission Period

When the input of the image signals to all of the pixels 140 is completed, one of the red-, green-, and blue-emissive light-emitting elements 114 is subsequently turned on. In the example shown in FIG. 10, the plurality of red-emissive light-emitting elements 114 of the light-source unit 110 are turned on, and red light is supplied to all of the pixels 140 in the first frame period. The period during which the light-emitting elements 114 emit light in each frame period is referred to as an emission period Pₑ. In the driving method according to an embodiment of the present invention, a relatively long emission period Pₑ is set for each frame period. Specifically, the ratio of the emission period Pₑ to one frame period is set to be equal to or greater than 0.25 and equal to or less than 0.83. Even when the refresh rate is set high (for example, when the refresh rate is 360 Hz), the time for the light-emitting element 114 to emit light can be set longer by setting such a long emission period Pₑ. Therefore, the luminance of the display device 100 can be improved. In other words, the power consumption of the display device 100 can be reduced.

When the emission period Pₑ ends, the light-emitting elements 114 are turned off, and then the polarity of the potential V_{com} applied to the common electrode 176 is reversed with respect to the potential of the pixel electrode 172 (i.e., the potential of the image signal). As a result, one frame period ends, and the display device shifts to the succeeding frame period (second frame period). The same operation is performed in the second frame period. However, the light-emitting elements 114 emitting light in the second frame period are different from the light-emitting elements 114 emitting light in the first frame period. That is, another one of the red-, green-, and blue-emissive light-emitting elements 114 is selected and emits light. In the example shown in FIG. 10, a plurality of green-emissive light-emitting elements 114 emit light in the emission period Pₑ. The same is applied to the third frame period following the second frame period, where the remaining one of the red-, green-, and blue-emissive light-emitting elements 114 is selected and emits light. In the example shown in FIG. 10, a plurality of blue-emissive light-emitting elements 114 emit light during the emission period Pₑ of the third frame period.

As mentioned above, the writing period P_{w} is set to be equal to or greater than 0.14 and equal to or less than 0.71 of one frame period. Thus, when the refresh rate is 360 Hz, i.e., when one frame period is 2.78 ms, for example, the writing period P_{w} can be kept to a relatively short period of about 1.2 to 1.3 ms. Furthermore, each transistor 150 remains in the off state until the next frame period after the input of the image signal to the pixel 140 is completed. For example, there is no need to provide a period for black display (called a refresh period during which the transistors 150 are turned on and a potential corresponding to 0 gray scale is applied to the pixel electrodes 172) after the emission period Pₑ in order to refresh all of the transistors 150. Therefore, the period during which the high potential is applied to the gate electrode 156 to turn on the transistor 150 is the writing period P_{w} divided by the number of gate lines 132 in each frame period and is approximately several microseconds, depending on the number of gate lines 132. This value is extremely short compared with the refresh period set in conventional display devices (about 200 to 300 microseconds for each row). Therefore, the degradation caused by the application of a high potential to the gate electrode 156 (such as the enhancement shift of the threshold voltage and the reduction of the on-current as well as the generation of dark spots caused by these phenomena) can be effectively suppressed. In particular, when the potential applied to the gate electrode 156 to turn on the transistor 150 is high (for example, when a polymer-dispersed liquid crystal is used as the liquid crystal layer 180), application of this driving method can effectively suppress degradation of the transistor 150, resulting in a highly reliable display device.

### (3) Response Period

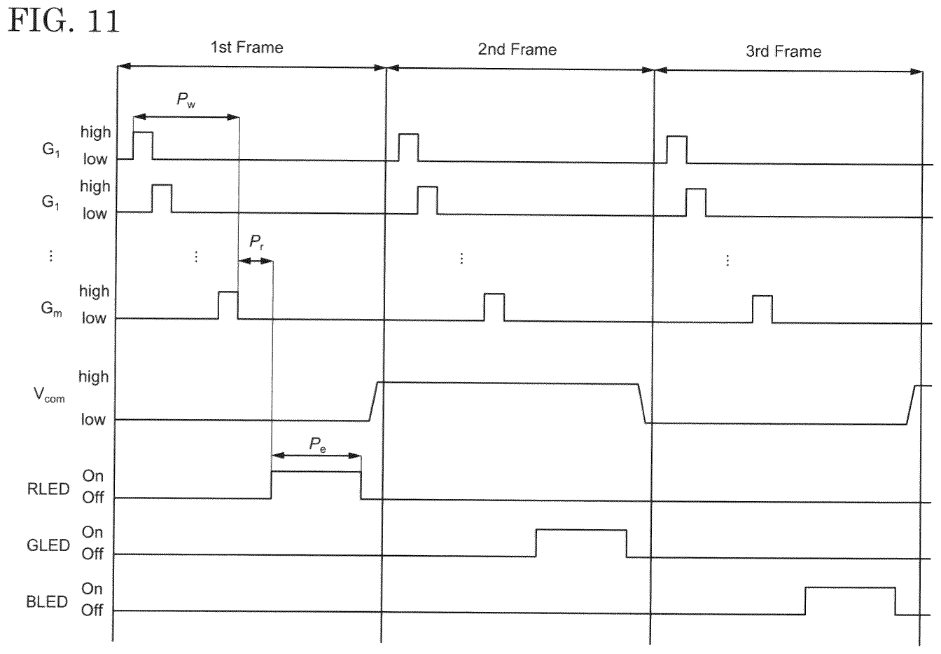

As an optional configuration, a period may be provided in each frame period for the liquid crystal molecules to shift to an alignment state corresponding to the image signal. Specifically, as shown in FIG. 11, a certain period may be provided after the input of the image signals to all of the pixels 140 is completed and before the emission period Pₑ starts. This period is called a response period Pᵣ. The response period Pᵣ may be set to be equal to or greater than 0.1 and equal to or less than 0.5 of each frame period. Therefore, even when the response period Pᵣ is provided, a sufficiently long emission period Pₑ can be secured, and a display device with low power consumption can be provided.

In addition, the refresh period is not provided in this driving method as described above. Therefore, when the image signals of different potentials are input to the pixel 140 between consecutive frame periods, the liquid crystal molecules may not be able to shift to the orientation state corresponding to the image signal, depending on the response speed of the liquid crystal molecules. However, the liquid crystal molecules are able to accurately take the alignment state corresponding to the potential of the image signal input in each frame period regardless of the potential of the image signal in the previous frame period by providing the response period Pᵣ. As a result, each pixel 140 can accurately provide the light with the gradation corresponding to the image signal, and the deterioration of display quality called whitewash can be prevented, for example.

### 4. Capacitance Adjustment of Storage Capacitor Element

As described above, each pixel 140 is provided with the liquid crystal element 170 and the storage capacitor element 144. The capacitance Cs of the storage capacitor element 144 is determined by the areas of the pair of electrodes, the distance therebetween, and the dielectric constant of the dielectric provided between the pair of electrodes and is constant regardless of the potential of the image signal. On the other hand, the liquid crystal element 170 is also a kind of capacitor element, and its capacitance Clc is determined by the areas of the pixel electrode 172 and the common electrode 176, the distance therebetween, and the dielectric constant of the liquid crystal layer 180. However, the dielectric constant of the liquid crystal layer 180 varies depending on the orientation state of the liquid crystal molecules. Therefore, the capacitance Clc of the liquid crystal element 170 changes with the potential of the image signal. The total capacitance of each pixel 140 (pixel capacitance) is the summation of the capacitance Cs and the capacitance Clc. Therefore, the pixel capacitance of each pixel 140 at the end of one frame period varies with the potential of the image signal input in that frame period. As a result, since the capacitance Clc changes according to the pixel voltage in the previous frame period, each frame period is affected by the potential of the image signal in the previous frame period, which may cause unevenness in the image and degradation of the display quality.

However, since the transistor 150 has extremely high mobility and low on-resistance, the capacitance Cs of the storage capacitor element 144 connected to the transistor 150 can be increased without affecting the time constant of the pixel 140. As a result, the ratio of the capacitance Clc with respect to the pixel capacitance can be reduced, by which the contribution of the capacitance Clc is relatively reduced, and the influence of the potential of the image signal in the previous frame period can be reduced.

For example, the capacitance Cs of the storage capacitor element 144 is increased. An increase in the capacitance Cs can be performed, for example, by increasing the area of the storage capacitor element 144. The increase in the capacitance Cs makes it possible to significantly increase the contribution of the capacitance Cs to the pixel capacitance while maintaining almost the same time constant of the pixel 140. In addition, since the mobility of the transistor 150 is further improved by providing the metal-oxide film 164 (see FIG. 7), the capacitance Cs of the storage capacitor element 144 can be further increased without affecting the time constant of the pixel 140. As a result, the influence of the capacitance Clc can be reduced.

Furthermore, the on-resistance may be further reduced by using the transistor 150 having the multi-channel as shown in FIG. 9. As a result, the capacitance Cs can be further increased without affecting the time constant of the pixel 140, and the contribution of the capacitance Cs to the pixel capacitance can be further increased. Although it depends on the size of the storage capacitor element 144, the distance between the electrodes, and the dielectric constant of the dielectric, it is also possible to increase the contribution of the capacitance Cs to the pixel capacitance by approximately twice compared with the case where a conventional transistor containing an oxide semiconductor is used as the transistor 150.

As described above, according to the liquid crystal device and its driving method of an embodiment of the present invention, it is possible not only to reduce power consumption and improve reliability by appropriately selecting the configuration of the transistor 150 but also to reduce or eliminate the influence resulting from the absence of the refresh period. Therefore, implementation of an embodiment of the present invention enables the production of a highly reliable display device with low power consumption and guaranteed display quality.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A driving method of a display device comprising a plurality of pixels each including a transistor in addition to a liquid crystal element electrically connected to the transistor and a red-emissive light-emitting element, a green-emissive light-emitting element, and a blue-emissive light-emitting element configured to apply light to the plurality of pixels, the driving method comprising, in a first frame period:
inputting image signals to the plurality of pixels:
turning on one of the red-emissive light-emitting element, the green-emissive light-emitting element, and the blue-emissive light-emitting element after inputting the image signals to the plurality of pixels; and
maintaining the transistors of the plurality of pixels in an off state after inputting the image signals into the plurality of pixels until a start of a second frame period subsequent to the first frame period.

2. The driving method according to claim 1,
wherein the liquid crystal element comprises a pixel electrode, a common electrode, and a liquid crystal layer, and
the driving method further comprises reversing a polarity of a potential of the common electrode with respect to potentials applied to the pixel electrodes after turning off the one of the red-emissive light-emitting element, the green-emissive light-emitting element, and the blue-emissive light-emitting element in the first frame period.

3. The driving method according to claim 1,
wherein a ratio of a period during which the one of the red-emissive light-emitting element, the green-emissive light-emitting element, and the blue-emissive light-emitting element is turned on with respect to the first frame period is equal to or greater than 0.25 and equal to or less than 0.83.

4. The driving method according to claim 1,
wherein a ratio of a period after completion of the input of the image signals to the plurality of pixels and before turning off the one of the red-emissive light-emitting element, the green-emissive light-emitting element, and the blue-emissive light-emitting element with respect to the first frame period is equal to or greater than 0.1 and equal to or less than 0.5.

5. The driving method according to claim 1, further comprising, in the second frame period:
inputting the image signals to the plurality of pixels;
turning on another one of the red-emissive light-emitting element, the green-emissive light-emitting element, and the blue-emissive light-emitting element after inputting the image signals to the plurality of pixels; and
maintaining the transistors of the plurality of pixels in an off state after inputting the image signals into the plurality of pixels until a start of a third frame period subsequent to the second frame period.

6. The driving method according to claim 1,
wherein the transistors each comprise at least one semiconductor film and a metal-oxide film in contact with the at least one semiconductor film.

7. The driving method according to claim 6, wherein the metal-oxide film contains aluminum oxide.

8. The driving method according to claim 6,
wherein the at least one semiconductor film includes a plurality of semiconductor films arranged parallel to one another.

9. The driving method according to claim 1,
wherein the display device further comprises an array substrate,
the plurality of pixels is arranged over the array substrate, and
the red-emissive light-emitting element, the green-emissive light-emitting element, and the blue-emissive light-emitting element are exposed from the plurality of pixels in a normal direction of a main surface of the array substrate.

10. A display device comprising:
a plurality of pixels each comprising a transistor and a liquid crystal element electrically connected to the transistor;
a driver circuit for controlling the plurality of pixels;
a red-emissive light-emitting element, a green-emissive light-emitting element, and a blue-emissive light-emitting element configured to apply light to the plurality of pixels; and
a light-source driver circuit for controlling the red-emissive light-emitting element, the green-emissive light-emitting element, and the blue-emissive light-emitting element,
wherein the driver circuit is configured to input image signals to the plurality of pixels in a first frame period,
the light-source driver circuit is configured to turn on one of the red-emissive light-emitting element, the green-emissive light-emitting element, and the blue-emissive light-emitting element after inputting the image signals to the plurality of pixels in the first frame period, and
the driver circuit is further configured to maintain the transistors of the plurality of pixels in an off state in the first frame period until a start of a second frame period subsequent to the first frame period.

11. The display device according to claim 10,
wherein the liquid crystal element comprises a pixel electrode, a common electrode, and a liquid crystal layer, and
the driver circuit is further configured to reverse a polarity of a potential of the common electrode with respect to potentials applied to the pixel electrodes after turning off the one of the red-emissive light-emitting element, the green-emissive light-emitting element, and the blue-emissive light-emitting element in the first frame period.

12. The display device according to claim 10,
wherein the transistor comprises at least one semiconductor film and a metal-oxide film in contact with the at least one semiconductor film.

13. The display device according to claim 12, wherein the metal-oxide film contains aluminum oxide.

14. The display device according to claim 12,
wherein the at least one semiconductor film includes a plurality of semiconductor films arranged parallel to one another.
